(19) United States
(12) Patent Application Publication
(10) Pub. No.: US 2017/0343024 A1
(43) Pub. Date: Nov. 30, 2017

(54) Automatically Adjustable Connection Structure

(71) Applicant: Shen Hao Metal Working Co., Ltd., Yilan City (TW)

(72) Inventors: A-Ming Chiang, Yilan City (TW); Wei-Ching Chiang, Yilan City (TW)

(21) Appl. No.: 15/357,083

(22) Filed: Nov. 21, 2016

(30) Foreign Application Priority Data
May 27, 2016 (TW) 105207994

(51) Int. Cl. F16B 9/02

(52) U.S. Cl. CPC F16B 9/023

(57) ABSTRACT

An automatically adjustable connection structure contains: a fixing member, a movable member, a limitation plate, and a limiting element. The fixing member includes a vertical sheet and a horizontal sheet having two guiding protrusions and an elongated orifice. The movable member is fixed on the horizontal sheet and includes a top piece and two peripheral pieces, the top piece has a hole corresponding to the elongated orifice, and each of the two peripheral pieces has each of two cutouts, wherein among the two cutouts and the horizontal sheet is defined a clamping space. The limitation plate inserts through the hole and the elongated orifice, wherein the movable member engages with and removes from the fixing member, such that the movable member adjustably slides relative to the fixing member via the elongated orifice of the horizontal sheet.

### BACKGROUND OF THE INVENTION

### Field of the Invention

The present invention relates to a connection structure, and more particularly to an automatically adjustable connection structure which is applied to connect at least one metal holding layer together.

### Description of the Prior Art

A conventional automatically adjustable connection structure is employed to connect a shelf/cabinet together so that objects are accommodated in the shelf/cabinet. The conventional automatically adjustable connection structure contains at least one metal holding layer, wherein each of the at least one metal holding layer is a metal storage basket or a metal mesh comprised of metal bars/iron cable welded together, and said each metal holding layer is fixed or is movable, wherein when said each metal holding layer is movable, two slidable rails are arranged on two peripheral sides of the shelf/cabinet so as to connect with said metal holding layer, hence the metal holding layer is pulled outwardly from the shelf/cabinet, and the objects are taken out of the shelf/cabinet. When said each metal holding layer is fixed, it is in connection with two peripheral sides of the shelf/cabinet, thus connecting the shelf/cabinet securely and reducing using space.

Said each metal holding layer and the two slidable rails are connected together by using a locking apparatus, and said each metal holding layer is connected with the two peripheral sides of the shelf/cabinet by way of the locking apparatus. However, the locking apparatus cannot adjust a width of said each metal holding layer and a distance between the two peripheral sides of said each metal holding layer when said each metal holding layer is machined poorly or distorts, an error between the width of said each metal holding layer and the distance between the two peripheral sides of said each metal holding layer occur, hence when said each metal holding layer is movable, it is pushed or puled unsmoothly and inconveniently. When said each metal holding layer is fixed, it cannot connect with the shelf/cabinet.

The present invention has arisen to mitigate and/or obviate the afore-described disadvantages.

### SUMMARY OF THE INVENTION

The primary objective of the present invention is to provide an automatically adjustable connection structure in which a movable member engages with or removes from a fixing member, the movable member adjustably slides on the fixing member, and when a metal holding layer connects two slidable rails together or when two metal holding layers couple with two racks together, and when the metal holding layer is not machined accurately or distorts, it is pushed and pulled smoothly, hence the two metal holding layers and the two racks are connected together smoothly.

An automatically adjustable connection structure provided by the present invention contains: a fixing member, a movable member, a limitation plate, and a limiting element.

The fixing member includes a vertical sheet and a horizontal sheet horizontally extending from a bottom of the vertical sheet, the horizontal sheet has two guiding protrusions symmetrically arranged on a top of the horizontal sheet adjacent to the two peripheral sides of the vertical sheet, and the horizontal sheet has an elongated orifice formed between the two guiding protrusions and extending away from the vertical sheet.

The movable member is fixed on the horizontal sheet of the fixing member, and the movable member includes a top piece and two peripheral pieces extending downwardly from two peripheral sides of the top piece, the top piece has a hole corresponding to the elongated orifice of the fixing member, the two peripheral pieces are fitted with the two guiding protrusions of the horizontal sheet respectively, and each of the two peripheral pieces has each of two cutouts which does not interfere with each of the two guiding protrusions of the fixing member, among the two cutouts of the two peripheral pieces and the horizontal sheet of the fixing member is defined a clamping space.

The limiting element inserts through the hole of the top piece of the movable member and the elongated orifice of the horizontal sheet of the fixing member, wherein the movable member engages with and removes from the fixing member, such that the movable member adjustably slides relative to the fixing member via the elongated orifice of the horizontal sheet.

### BRIEF DESCRIPTION OF THE DRAWINGS

FIG. 1 is a perspective view showing the exploded components of an automatically adjustable connection structure in accordance with a preferred embodiment of the present invention.

FIG. 2 is a perspective view showing the assembly of the automatically adjustable connection structure in accordance with the preferred embodiment of the present invention.

FIG. 3 is a cross sectional view showing the assembly of the automatically adjustable connection structure in accordance with the preferred embodiment of the present invention.

FIG. 4 is a perspectival view showing an application of the automatically adjustable connection structure in accordance with the preferred embodiment of the present invention.

FIG. 5 is a partially perspectival view showing the application of the automatically adjustable connection structure in accordance with the preferred embodiment of the present invention.

FIG. 6 is another perspectival view showing the application of the automatically adjustable connection structure in accordance with the preferred embodiment of the present invention.

FIG. 7 is a cross sectional view showing the application of the automatically adjustable connection structure in accordance with the preferred embodiment of the present invention.

FIG. 8 is a partially perspectival view showing another application of the automatically adjustable connection structure in accordance with the preferred embodiment of the present invention.

FIG. 9 is another partially perspectival view showing said another application of the automatically adjustable connection structure in accordance with the preferred embodiment of the present invention.

FIG. 10 is a cross sectional view showing said another application of the automatically adjustable connection structure in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

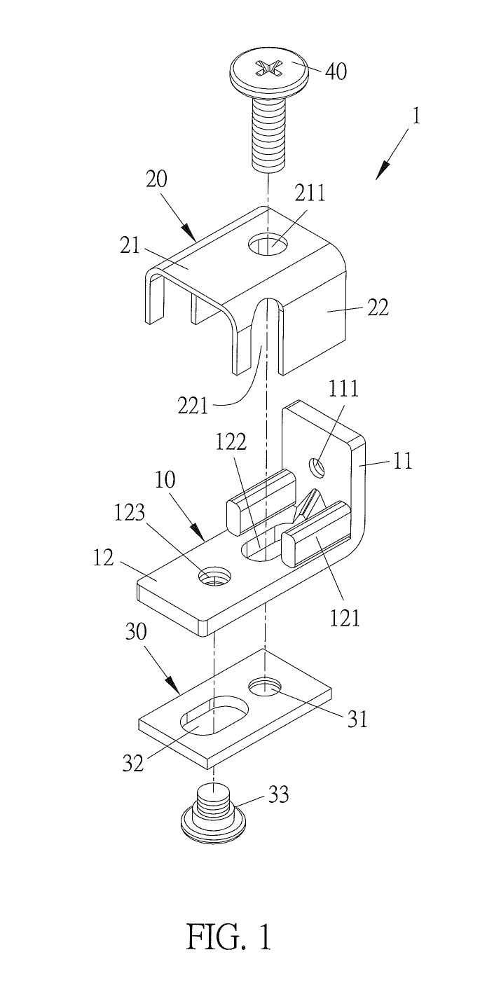

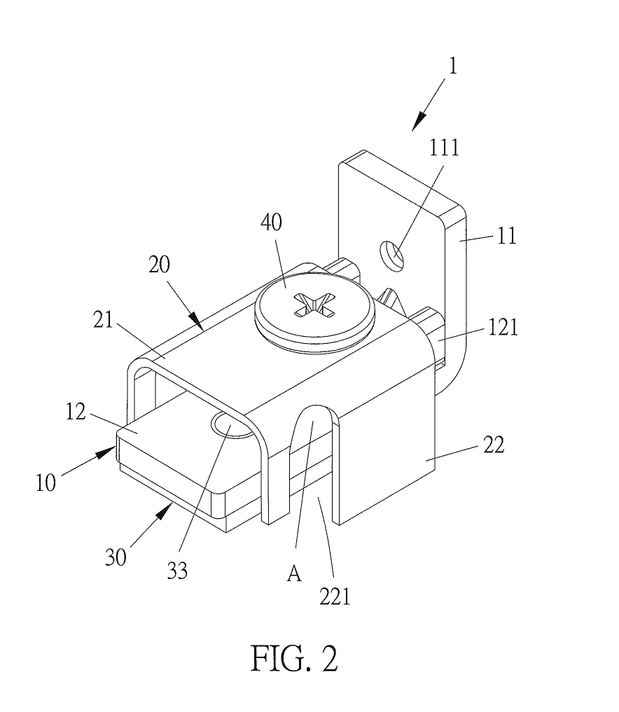

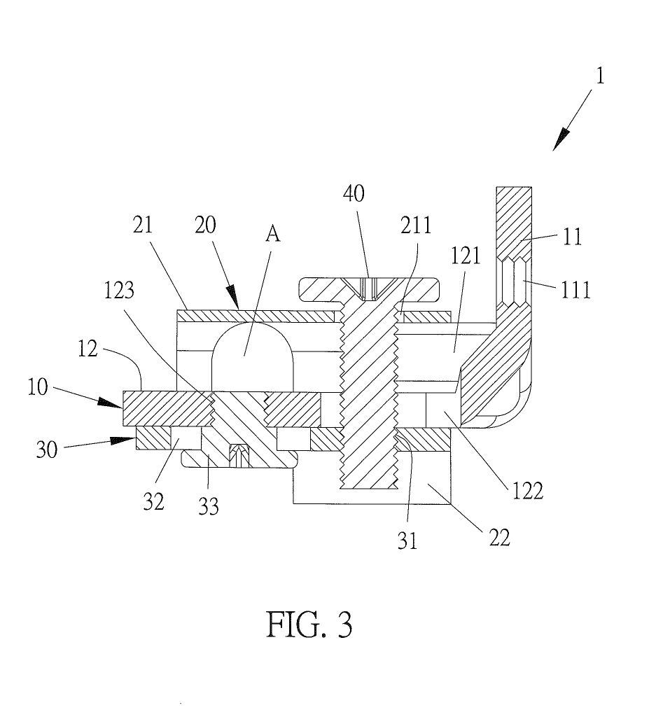

Referring to FIGS. 1-3, an automatically adjustable connection structure 1 according to a preferred embodiment of the present invention comprises: a fixing member 10, a movable member 20, a limitation plate 30, and a limiting element 40.

The fixing member 10 includes a vertical sheet 11 and a horizontal sheet 12 horizontally extending from a bottom of the vertical sheet 11, wherein the vertical sheet 11 has a locking orifice 111 defined thereon, the horizontal sheet 12 has two guiding protrusions 121 symmetrically arranged on a top of the horizontal sheet 12 adjacent to the two peripheral sides of the vertical sheet 11, an elongated orifice 122 formed between the two guiding protrusions 121 and extending away from the vertical sheet 11, and a screwing orifice 123 defined on a bottom of the horizontal sheet 12 and not interfering the two guiding protrusions 121 and the elongated orifice 122.

The movable member 20 is fixed on the horizontal sheet 12 of the fixing member 10, and the movable member 20 includes a top piece 21 and two peripheral pieces 22 extending downwardly from two peripheral sides of the top piece 21, wherein the top piece 21 has a hole 211 corresponding to the elongated orifice 122 of the fixing member 10, the two peripheral pieces 22 are fitted with the two guiding protrusions 121 of the horizontal sheet 12 respectively, and each of the two peripheral pieces 22 has each of two cutouts 221 which does not interfere with each of the two guiding protrusions 121 of the fixing member 10, wherein among the two cutouts 221 of the two peripheral pieces 22 and the horizontal sheet 12 of the fixing member 10 is defined a clamping space A.

The limitation plate 30 contacts with a bottom of the fixing member 10, and the limitation plate 30 includes a through opening 31 corresponding to the elongated orifice 122 of the fixing member 10 and includes an elongated defining opening 32 corresponding to the screwing orifice 123 of the fixing member 10, wherein the elongated defining opening 32 accommodates a screw bolt 33 and screwing with the screwing orifice 123 of the fixing member 10 so that the limitation plate 30 adjustably slides on the fixing member 10 through the elongated defining opening 32.

The limiting element 40 is screwed with the through opening 31 of the limitation plate 30 via the hole 211 of the top piece 21 of the movable member 20 and the elongated orifice 122 of the horizontal sheet 12 of the fixing member 10, and the movable member 20 engages with and removes from the fixing member 10, such that the movable member 20 adjustably slides relative to the fixing member 10 via the elongated orifice 122 of the horizontal sheet 12.

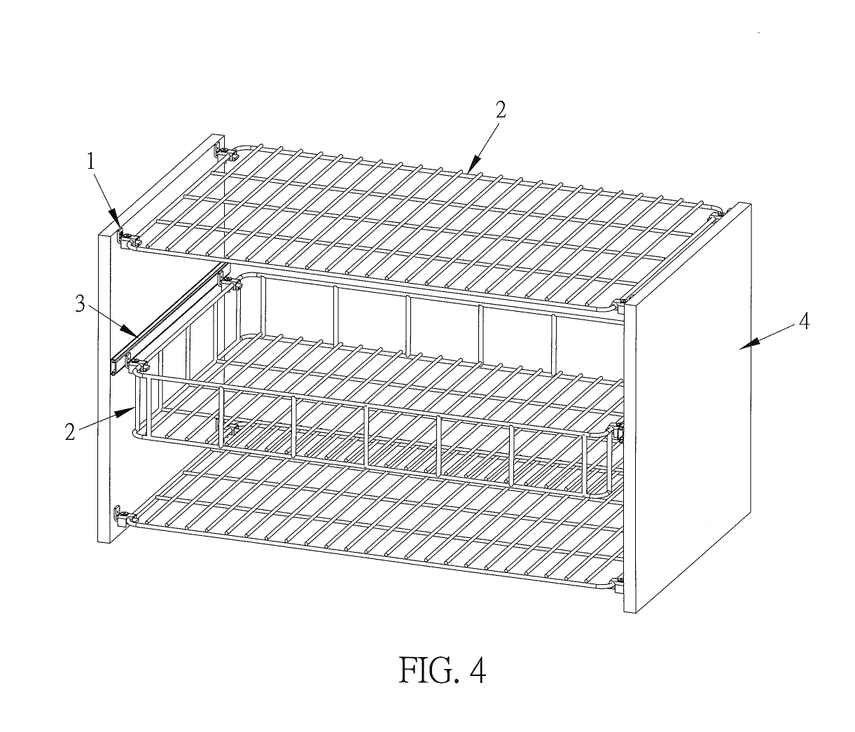

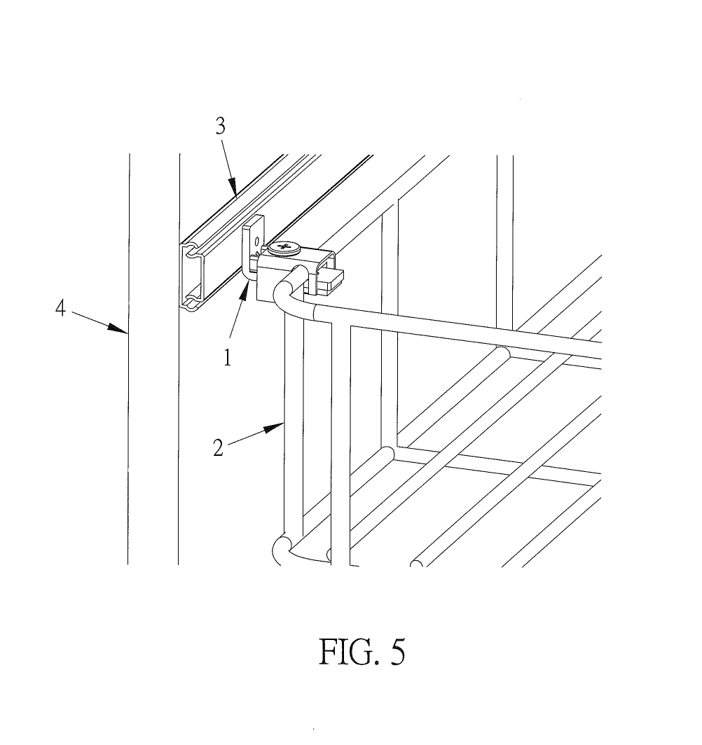

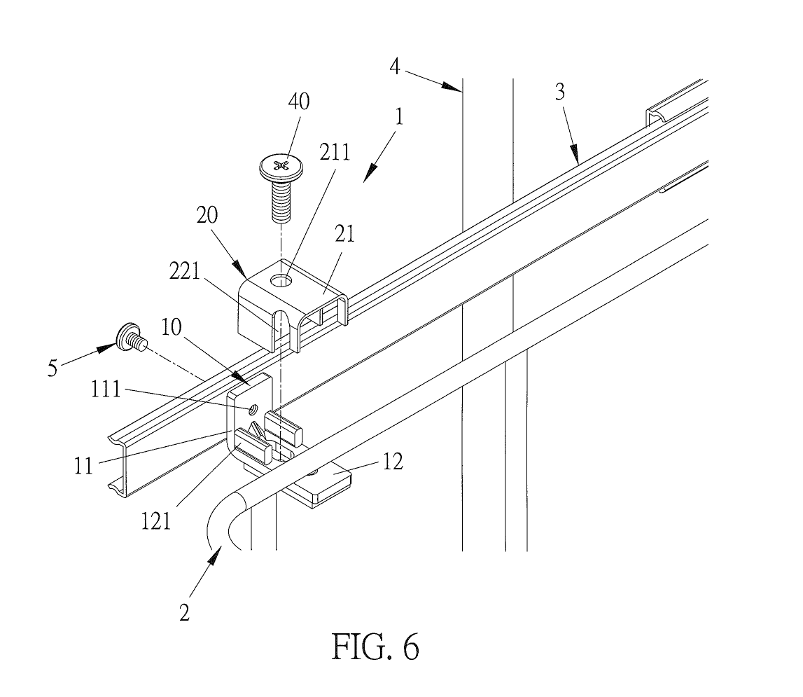

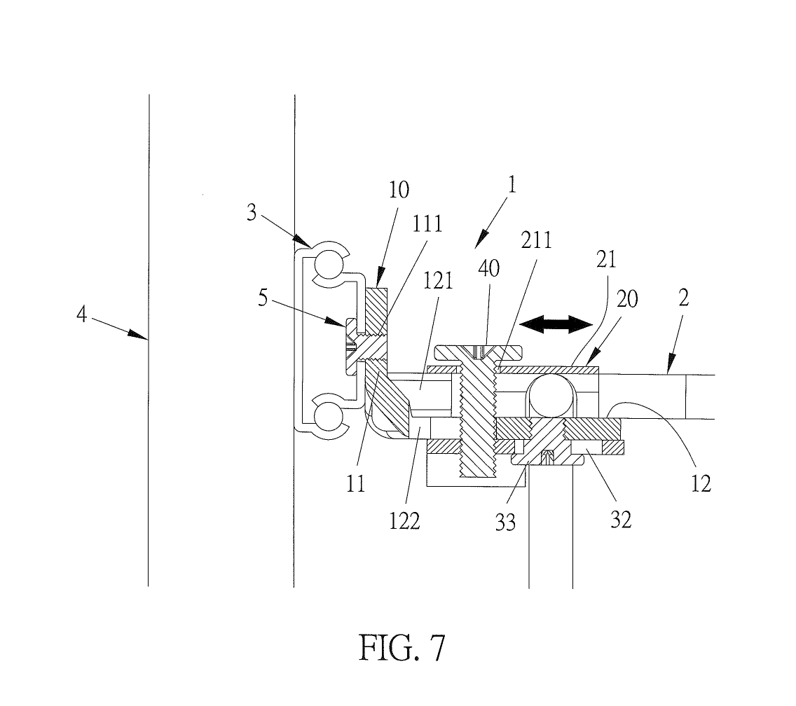

In operation, as shown in FIG. 4, the automatically adjustable connection structure 1 is applied to connect a metal holding layer 2 and two slidable rails 3 together or to connect two metal holding layers 2 and two racks 4 together, wherein each of the two metal holding layers 2 is comprised of metal bars/iron cables welded together or the metal holding layer 2 is a metal storage basket or a metal mesh comprised of metal bars/iron cables welded together. When the metal holding layer 2 is in connection with the two slidable rails 3, as shown in FIGS. 5-7, the locking orifice 111 of the vertical sheet 11 is locked on each of the two slidable rails 3 by way of a locking element 5, two ribs on two peripheral sides of the metal holding layer 2 are retained in the two cutouts 221 of the movable member 20 respectively so as to form the clamping space A, thus connecting the metal holding layer 2 and the two slidable rails 3 together. Because the movable member 20 adjustably slides relative to the fixing member 10 via the elongated orifice 122 of the horizontal sheet 12, when the metal holding layer 2 is not machined accurately or distorts, it is pushed and pulled smoothly.

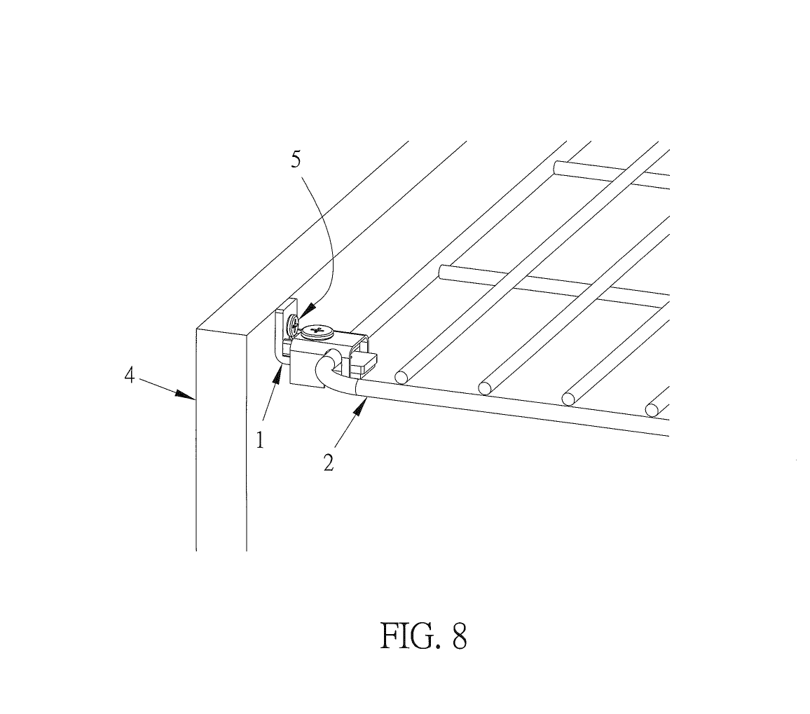

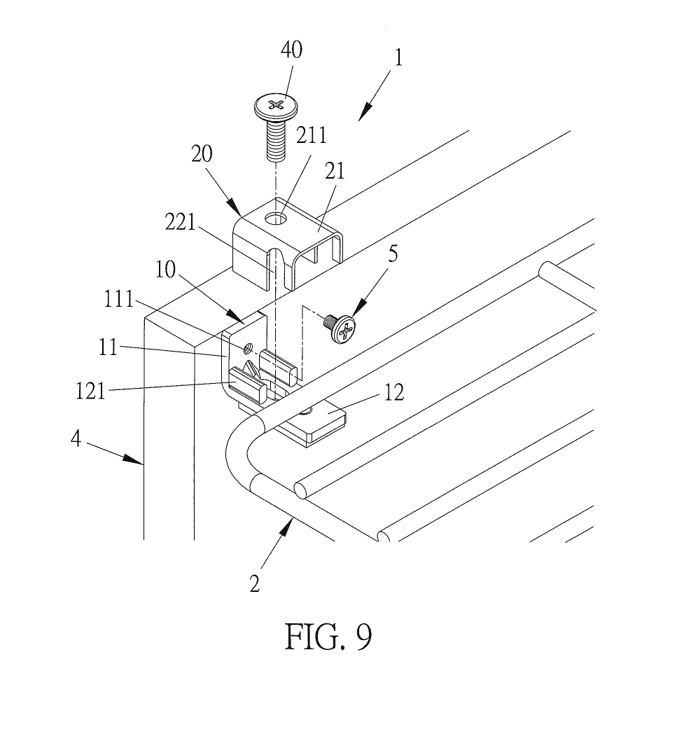

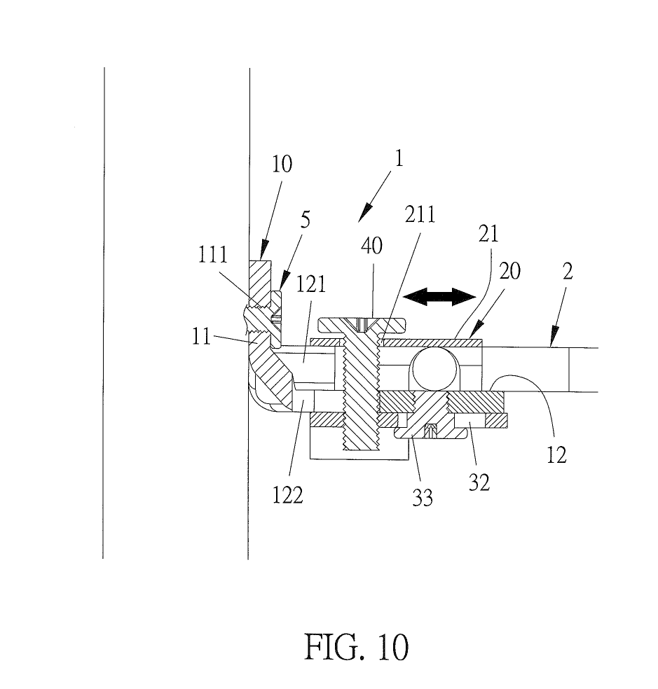

When the two metal holding layers 2 and the two racks 4 are connected together, as illustrated in FIGS. 8 to 10, the locking orifice 111 of the vertical sheet 11 of the fixing member 10 is locked on each of the two racks 4 by way of a locking element 5, two ribs on two peripheral sides of the metal holding layer 2 are retained in the two cutouts 221 of the movable member 20 respectively so as to form the clamping space A with the horizontal sheet 12 of the fixing member 10, thus connecting the two metal holding layers 2 and the two racks 4 together. Since the movable member 20 automatically slides relative to the fixing member 10 via the elongated orifice 122 of the horizontal sheet 12, when the metal holding layer 2 is not machined accurately or distorts, the two metal holding layers 2 and the two racks 4 are connected together smoothly.

Accordingly, the movable member 20 of the automatically adjustable connection structure 1 engages with or removes from the fixing member 10, the movable member 20 adjustably slides on the fixing member 10, and when the metal holding layer 2 connects two slidable rails 3 together or when the two metal holding layers 2 couple with two racks 4 together, and when the metal holding layer 2 is not machined accurately or distorts, it is pushed and pulled smoothly, hence the two metal holding layers 2 and the two racks 4 are connected together smoothly.

While we have shown and described various embodiments in accordance with the present invention, it is clear to those skilled in the art that further embodiments may be made without departing from the scope of the present invention.

What is claimed is:

1. An automatically adjustable connection structure comprising:
a fixing member including a vertical sheet and a horizontal sheet horizontally extending from a bottom of the vertical sheet, the horizontal sheet having two guiding protrusions symmetrically arranged on a top of the horizontal sheet adjacent to the two peripheral sides of the vertical sheet, and the horizontal sheet having an elongated orifice formed between the two guiding protrusions and extending away from the vertical sheet;
a movable member fixed on the horizontal sheet of the fixing member, and the movable member including a top piece and two peripheral pieces extending downwardly from two peripheral sides of the top piece, the top piece having a hole corresponding to the elongated orifice of the fixing member, the two peripheral pieces being fitted with the two guiding protrusions of the horizontal sheet respectively, and each of the two peripheral pieces having each of two cutouts which does not interfere with each of the two guiding protrusions of the fixing member, among the two cutouts of the two peripheral pieces and the horizontal sheet of the fixing member being defined a clamping space; and
a limiting element inserting through the hole of the top piece of the movable member and the elongated orifice of the horizontal sheet of the fixing member, wherein the movable member engages with and removes from the fixing member, such that the movable member adjustably slides relative to the fixing member via the elongated orifice of the horizontal sheet.

2. The automatically adjustable connection structure as claimed in claim 1, wherein the vertical sheet of the fixing member has a locking orifice defined thereon.

3. The automatically adjustable connection structure as claimed in claim 1, wherein the elongated orifice of the fixing member extends away from the vertical sheet.

4. The automatically adjustable connection structure as claimed in claim 1, wherein the horizontal sheet of the fixing member has a screwing orifice defined on a bottom thereof and not interfering the two guiding protrusions and the elongated orifice, the automatically adjustable connection structure further comprises a limitation plate contacting with a bottom of the fixing member, and the limitation plate includes a through opening corresponding to the elongated orifice of the fixing member and includes an elongated defining opening corresponding to the screwing orifice of the fixing member, wherein the elongated defining opening accommodates a screw bolt and screwing with the screwing orifice of the fixing member so that the limitation plate adjustably slides on the fixing member through the elongated defining opening.
